(19) United States
(12) Patent Application Publication
(10) Pub. No.: US 2013/0180607 A1
(43) Pub. Date: Jul. 18, 2013

(54) VALVE WITH PRESSURE CONTROL FUNCTION

(71) Applicant: Christian Graspeuntner, Hallein (AT)

(72) Inventor: Christian Graspeuntner, Hallein (AT)

(73) Assignee: Robert Bosch GmbH, Stuttgart-Feuerbach (DE)

(21) Appl. No.: 13/876,286

(22) PCT Filed: Sep. 27, 2011
(86) PCT No.: PCT/AT2011/000395

§ 371 Date: Mar. 27, 2013

(30) Foreign Application Priority Data
Sep. 27, 2010 (AT) 1612/2010

(51) Int. Cl. F02M 63/00

(52) U.S. Cl. CPC F02M 63/005
USPC 137/540

(57) ABSTRACT

In a valve with pressure control function for common-rail heavy oil injection systems for internal combustion engines, including a valve support, a valve piston movably arranged in the valve support and interacting with a valve seat with the valve closed, and a compression spring applying a compressive force on the valve piston in the closing direction, a pin acting on the valve piston in the closing direction is arranged to be movable by the aid of an actuating means against the compressive force of the compression spring for controllably opening the valve so as to provide a flushing function.

The invention relates to a valve with pressure control function for common-rail heavy oil injection systems for internal combustion engines, including a valve support, a valve piston movably arranged in the valve support and interacting with a valve seat with the valve closed, and a compression spring applying a compressive force on the valve piston in the closing direction.

The invention further relates to a fuel supply device for common-rail heavy oil injection systems for internal combustion engines, including a tank, a pre-supply pump for supplying heavy oil from the tank to a high-pressure pump, said high-pressure pump via at least one high-pressure line being connected to a high-pressure accumulator (rail) feeding at least one injector, and further including a valve connected to the high-pressure accumulator via a separate high-pressure line for discharging at least a partial amount of the heavy oil into the tank via a return duct, if required.

A pressure control valve of the initially defined kind serves to limit the pressure in a high-pressure accumulator (rail) while simultaneously providing an emergency drive feature. The pressure control valve, as a rule, is screwed in on the rail, contacting the highly compressed fuel by a spring-loaded valve pin via a sealing seat. On the rear side of the sealing seat, the valve is connected to the low-pressure return channel of the common-rail system via a line. If the rail pressure varies within the admissible range, the valve remains closed due to the applied spring force, and is tight relative to the return channel. If, in the case of an error, the maximally admissible rail pressure is exceeded, the valve will be opened, thus restricting the system pressure. A pressure control valve is, for instance, described in WO 2004/083695 A1.

For cost reasons, lower-quality fuels such as, for instance, heavy oil are used for very large diesel engines, particularly marine diesel engines. Due to the specific physical properties of heavy oils, special operation measures have to be taken. The viscosity of heavy oil is, for instance, substantially higher than that of regular diesel fuel such that heating to above 80° C. is required to enable the pumping of heavy oil at all.

The high viscosity of heavy oil requires fuel to be constantly pumped in circulation within the line system, even at a standstill of the engine, in order to prevent the solidification of heavy oil in the lines.

To this end, heavy oil common-rail injection systems comprise a flush valve, which is closed during the operation of the engine so as to close the high-pressure-side parts of the fuel system, and hence also the rail, relative to a low-pressure-side fuel return line, through which fuel can be returned back into the tank. At a standstill of the engine, the flush valve can be opened so as to cause fuel to be recirculated from the high-pressure side through the high-pressure lines and the rail via the valve to the low-pressure side and, subsequently, into the tank, wherein the fuel is maintained at an appropriate temperature by a preheater so as to prevent the solidification of the heavy oil in the lines.

In addition to enabling the creation of a recirculation flow for tempering the fuel in the system, the flush valve, at the same time, also functions as an emergency stop valve. By suitably controlling the flush valve, the system pressure can be lowered very quickly in case of emergency without having to deactivate the injectors themselves.

In conventional common-rail systems, the pressure control valve and the flush valve are configured as mutually separate components and, therefore, connected to the rail in different points. This requires high construction and production expenditures. The present invention, therefore, aims to avoid the cited drawbacks without affecting the lifetime or operational safety of the valves.

To solve this object, the valve of the initially defined kind according to the invention is further developed to the effect that a pin acting on the valve piston in the closing direction is arranged to be movable by the aid of an actuating means against the compressive force of the compression spring to controllably open the valve so as to provide a flushing function. The valve thus constitutes a combination of the pressure control valve and the flush valve, yet with the two valves operating independently of each other using the same valve seat. In a preferred manner, the compression spring of the valve simultaneously acts as a compression spring determining the opening pressure of the pressure control function of the valve and as a compression spring for the flush valve function. The compression spring, in particular, acts on the valve piston via the interposed pin in the closing direction. Due to the fact that the compression spring does not directly act on the valve piston of the valve but via said interposed pin, the flushing function is enabled in addition to the pressure control function, wherein said actuating means serves to apply a force that acts against the compression spring, thus causing the lifting of the pin, and hence the release of the valve piston, so as to enable the valve piston to lift off the valve seat due to the pressure exerted on the high-pressure side and to release the flow cross section required for the flushing function. The pressure control function of the valve will, however, remain completely unaffected as long as the actuating means is not activated. Thus, it is, for instance, also possible in a conventional manner to adjust the opening pressure of the pressure control valve, to which end the configuration is preferably devised such that the compression spring, on the side facing away from the pin, is held via an interposed adjusting disc.

In principle, the actuating means for actuating the pin in the opening direction, i.e. against the force of the compression spring, can be configured in any manner whatsoever as long as the required actuating force will be ensured. The actuating force, which may, for instance, be applied hydraulically, magnetically or pneumatically, could basically be caused to directly act on the pin. In order to provide an adequate actuating force, an accordingly large contact surface will, as a rule, be required, thus involving an accordingly large mass of the pin. At the same time, it is sought to keep the mass of the pin as low as possible in order to minimize the inertia of the valve for the optimum mode of operation of the pressure control function. A preferred configuration that takes into account the two mentioned contradictory requirements, i.e. to provide an adequate actuating force and to minimize the inertia of the system, contemplates that the actuating means comprises an actuating piston movably mounted in a cylinder and capable of being brought into operative connection with a contact surface of the pin for displacing the pin against the compressive force of the compression spring. The force for actuating the pin against the compression spring thus takes effect on a separate actuating piston entraining the pressure pin in the opening direction, rather than directly on the pin. Conversely, a movement of the pin will not carry along the actuating piston.

In order to prevent the actuating piston from interfering with the pin in the closing direction in such a manner that the force of the compression spring may not fully act on the valve piston, a further preferred configuration contemplates that an axial gap is provided between the contact surface of the pin and the respective counter-surface of the piston in the closed state of the valve.

In an advantageous manner, the actuating piston is designed to be pot-shaped, comprising guide surfaces on its inner periphery for axially guiding the pin.

As already pointed out, the actuation of the actuating piston can be performed in any manner whatsoever. A particularly operationally safe and proven actuation is performed in that the actuating means comprises a pneumatic means for applying pressure on the actuating piston in the opening direction. In this respect, it may, in particular, be provided that a line capable of being charged with a pressure medium, in particular compressed air, opens into a chamber delimited by the actuating piston and disposed on the side of the actuating piston facing away from the compression spring.

In order to ensure the resetting of the actuating piston after its displacement, which is required for opening the flushing cross section, it is preferably contemplated that a further compression spring directly acting on the actuating piston in the closing direction of the valve is provided. In this respect, a particularly space-saving construction is preferably achieved in that the further compression spring acting on the actuating piston and the compression spring acting on the valve piston are coaxially arranged. The compression springs, in particular, can be arranged in a manner that the further compression spring acting on the actuating piston surrounds the compression spring acting on the valve piston.

A compact and modular mode of construction will advantageously result in that a high-pressure bore leading to the valve seat and at least one flow-off channel are formed in the valve support. The valve support is, in particular, detachably connected, particularly screwed, to the component comprising the actuating means.

In the following, the invention will be explained in more detail by way of an exemplary embodiment schematically illustrated in the drawing. Therein,

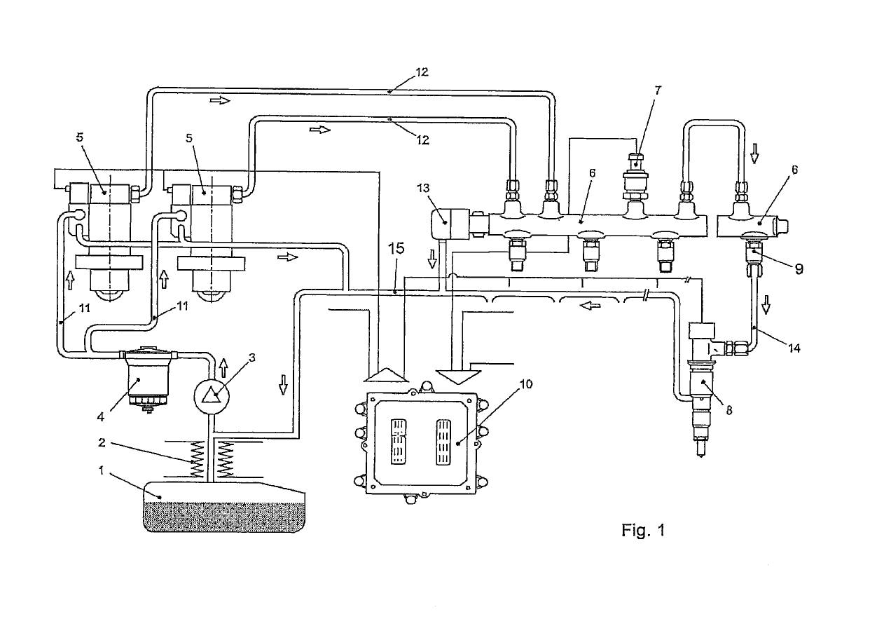

FIG. 1 illustrates a fuel supply installation; and

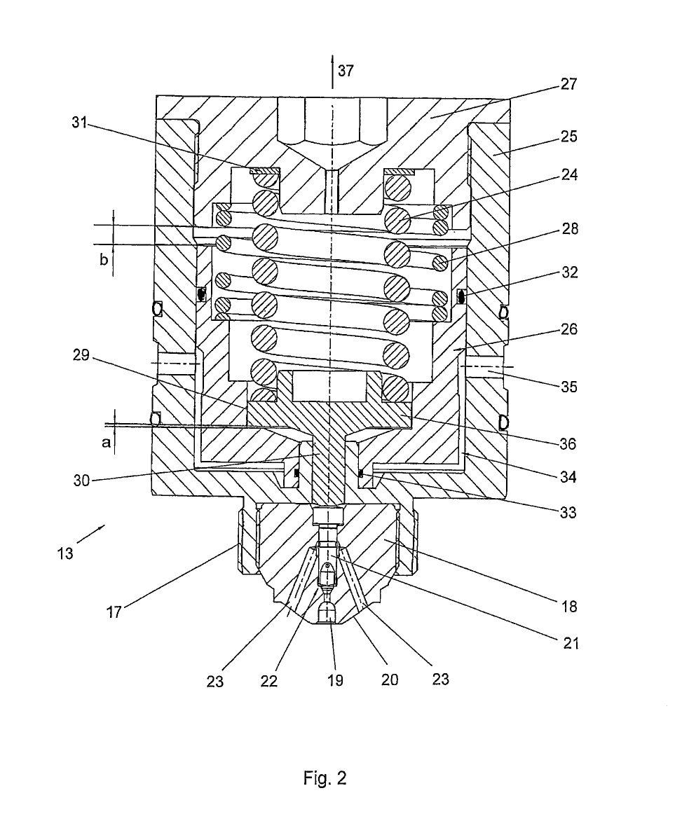

FIG. 2 depicts a cross section through a valve according to the invention.

In FIG. 1, a common-rail heavy oil injection system is schematically illustrated. From a tank 1, fuel heated in a preheater 2 is supplied by a pre-supply pump 3, via a fuel filter 4 and fuel lines 11, to at least one high-pressure pump 5, where the fuel is compressed to system pressures of above 1400 bar. The compressed fuel, via high-pressure lines 12, reaches at least one rail 6 that is, inter alia, equipped with at least one pressure control and flush valve 13 and a rail pressure sensor 7. The pressure in the rail 6 is adjusted by controlling the amount of fuel delivered by the high-pressure pump 5 into the high-pressure line 12, using a control device 10. Departing from the rail 6, the fuel reaches an injector 8 via a flow restrictor 9 through a high-pressure line 14, which injector is likewise controlled by the control device 10. The amount of fuel required for the function of the injector 8 is returned into the tank 1 via low-pressure lines 15. In order to be able to ensure the circulation of the fuel in the line system even during a standstill of the engine, a low-pressure line leads from the pressure control and flush valve 13 to the tank 1 so as to enable a partial amount of the fuel to be directly returned into the tank 1 via the low-pressure line 15.

FIG. 2 depicts in detail the pressure control and flush valve 13 according to the invention. The valve 13 comprises a fixing thread 17, by which it can be screwed into the rail 6, wherein the valve support 18 comprises a sealing cone 20 for connecting the high-pressure supply line 19 to the rail 6. The valve piston of the valve 13 is denoted by 21 and can be pressed against the valve seat 22 by the aid of a compression spring 24. When a predetermined pressure in the rail 6 is exceeded, the valve piston 21 is lifted off the valve seat 22, and fuel is discharged via the flow-off channels 23. Concerning the configuration of this pressure control function, it is also referred to the pressure control valve described in WO 2004/083695 A1.

For the flushing function, a cylinder 25 is additionally provided, in which an actuating piston 25 designed in a pot-shaped manner is guided so as to be movable in the axial direction. An external piston seal 32 and an internal piston seal 33 are provided for sealing. The actuating piston 26 is acted upon by a compression spring 28 supported on a shoulder of the lid 27. A pin 30 is movably guided in the axial direction on cylindrical guide surfaces 29 of the actuating piston 26, said pin 30 being actuated by the compression spring 24, which is supported on the lid 27 via an interposed adjusting disc 31.

The assembly of the valve 13 is effected in a manner that the valve support 18 is at first screwed with the appropriate torque into the cylinder 25 as a prefinished unit comprising the valve piston 21 and the like. After this, the actuating piston 26 is inserted into the cylinder 25 with premounted seals 32 and 33. Subsequently, the compression springs 24 and 28 are inserted. After having adjusted the opening pressure of the pressure control valve by the aid of the adjusting disc 31, the lid 27 is finally screwed in.

For the flushing function, compressed air is applied to the chamber 34 via the opening 35, thus powering the actuating piston 26 in the opening direction. After having overcome the idle stroke defined by the axial gap a, the actuating piston 26 lifts the pin 30 upwardly until reaching the stroke stop while overcoming the piston stroke b. To this end, the actuating piston 26 interacts with a stop surface formed on the lower side of a disc 36, which is configured to have an enlarged diameter. In doing so, the valve piston 21 is completely lifted off the valve seat 22 so as to provide the appropriate cross section for the flushing operation. When the actuating piston 26 is no longer powered with air, the two compression springs 24 and 28 at first press the pin 30 and the valve piston 21 into the starting position, and then the compression spring 28 presses the actuating piston into starting position.

For the pressure control function, only the compression spring comes into effect, the difference from a conventional pressure control valve merely being that the compression spring 24 acts on the valve piston 21 via the interposed pin 30.

The inner volume of the cylinder 25 is filled with heavy oil. A leakage opening for the outflow of heavy oil is denoted by 37.

The present invention thus allows for the combination of the pressure control valve and the flush valve. The advantages consequently comprise a compact mode of construction, low costs and the requirement of only a single high-pressure connection.

1. A valve with pressure control function for common-rail heavy oil injection systems for internal combustion engines, including a valve support (18), a valve piston (21) movably arranged in the valve support (18) and interacting with a valve seat (22) with the valve closed, and a compression spring (24) applying a compressive force on the valve piston (21) in the closing direction, characterized in that a pin (30) acting on the valve piston (21) in the closing direction is arranged to be movable by the aid of an actuating means against the compressive force of the compression spring (24) to controllably open the valve so as to provide a flushing function.

2. A valve according to claim 1, characterized in that the compression spring (24) acts on the valve piston (21) in the closing direction via the interposed pin (30).

3. A valve according to claim 1, characterized in that the compression spring (24), on the side facing away from the pin (30), is held via an interposed adjusting disc (31).

4. A valve according to claim 1, characterized in that the actuating means comprises an actuating piston (26) movably mounted in a cylinder (25) and capable of being brought into operative connection with a contact surface of the pin (30) for displacing the pin (30) against the compressive force of the compression spring (24).

5. A valve according to claim 4, characterized in that an axial gap (a) is provided between the contact surface of the pin (30) and the respective counter-surface surface of the actuating piston (26) in the closed state of the valve.

6. A valve according to claim 4, characterized in that the actuating piston (26) is designed to be pot-shaped, comprising guide surfaces (29) on its inner periphery for axially guiding the pin (30).

7. A valve according to claim 4, characterized in that the actuating means comprises a pneumatic means for applying pressure on the actuating piston (26) in the opening direction.

8. A valve according to claim 4, characterized in that a line capable of being charged with a pressure medium, in particular compressed air, opens into a chamber (34) delimited by the actuating piston (26) and disposed on the side of the actuating piston (26) facing away from the compression spring (24).

9. A valve according to claim 4, characterized in that a further compression spring (28) directly acting on the actuating piston (26) in the closing direction of the valve is provided.

10. A valve according to claim 9, characterized in that the further compression spring (28) acting on the actuating piston (26) and the compression spring (24) acting on the valve piston (21) are coaxially arranged.

11. A valve according to claim 9, characterized in that the further compression spring (28) acting on the actuating piston (26) surrounds the compression spring (24) acting on the valve piston (21).

12. A valve according to claim 1, characterized in that a high-pressure bore (19) leading to the valve seat (22) and at least one flow-off channel (23) are formed in the valve support (18).

13. A valve according to claim 1, characterized in that the valve support (18) is detachably connected, particularly screwed, to the component comprising the actuating means.

14. A fuel supply device for common-rail heavy oil injection systems for internal combustion engines, including a tank (1), a pre-supply pump (3) for supplying heavy oil from the tank (1) to a high-pressure pump (5), said high-pressure pump (5) via at least one high-pressure line (12) being connected to a high-pressure accumulator (rail) (6) feeding at least one injector (8), and further including a valve (13) connected to the high-pressure accumulator (6), preferably via a separate high-pressure line, for discharging at least a partial amount of the heavy oil into the tank (1) via a return duct (15), if required, characterized in that the valve (13) is configured as a valve (13) comprising a pressure control function and a flushing function, in particular according to any one of claims 1 to 13, wherein both of said valve functions work independently of each other using the same valve seat (22).
